(19) United States
(12) Patent Application Publication
(10) Pub. No.: US 2020/0235762 A1
(43) Pub. Date: Jul. 23, 2020

(54) RECONFIGURABLE WIRELESS CONVERTER

(71) Applicant: ELECTRONIC DESIGN & DEVELOPMENT, CORP., Tucson, AZ (US)

(72) Inventors: Sergio E. Cardona, Jr., Tucson, AZ (US); Kevin W. Patrick, Tucson, AZ (US); Joel Blumke, Tucson, AZ (US); Silvio Cardero, Tucson, AZ (US)

(21) Appl. No.: 16/750,337

(22) Filed: Jan. 23, 2020

Related U.S. Application Data
(60) Provisional application No. 62/795,934, filed on Jan. 23, 2019.

(51) Int. Cl. H04B 1/00; H01P 1/15; H04B 7/06; H04B 7/08

(52) U.S. Cl. CPC H04B 1/0067; H04B 7/0831; H04B 7/0619; H01P 1/15

(57) ABSTRACT

Multi-input, multi-output reconfigurable wireless converters are described herein. The wireless converter includes a plurality of signal converters, a plurality of wireless transceivers, a plurality of antennas, a switch matrix, and a field programmable gate array (FPGA). The wireless converter may further have a plurality of input transceivers. Each signal converter may have an input, an output, a transmit channel, a receive channel, a first switch, and a second switch.

### CROSS-REFERENCES TO RELATED APPLICATIONS

This application is a non-provisional and claims benefit of U.S. Patent Application No. 62/795,934, filed Jan. 23, 2019, the specification(s) of which is/are incorporated herein in their entirety by reference.

### BACKGROUND OF THE INVENTION

### i. Field of the Invention

The present invention relates to wireless converters, in particular, to multi-input, multi-output reconfigurable wireless converters.

### ii. Description of Related Art Including Information Disclosed

The wireless device is software-defined radio system, which is made up of a radio, converter, local oscillators, multipliers and discrete antenna elements that can operate at any frequency, any band, and any protocol. The novelty is that it will be able to interface or connect any of existing devices to future 5G protocols and beyond. Furthermore, the device can be use both as a radio and radar by being able to update via software the right algorithms for those specific applications. The dynamic range of the device allows for lower than −90 dBm of sensitivity at 5G frequencies making it first in the market and allowing for substantial range from its base. The device does this by utilizing up to 8 channels of transmit and receive radio frequency paths. The device is made up of 8 discrete transmit and receive converters that up converts to 5G frequencies or any other frequency with beyond 1 GHz bandwidth capability. It utilizes local oscillators that can provide −135 dBc/Hz phase noise at 10 kHz from carrier providing substantial benefit to the 5G movement. The 8 different T/R converters are routed to 54 different organic-base antenna designs that provide 20 degrees beam width with 17 dBi of gain at 28 GHz. The system generates up to more than 40 W of radiated power per element. There are more than 432 radio frequency traces embedded into an organic board that operates at 28 GHz. By doing this, the device has substantially reduced the cost of the hardware by eliminating all of the cable/connectors. Existing software defined radios do not have the built-in flexibility of cost and capability. 5G radios have a difficult time going through buildings and glass.

Similar radios at these frequencies do not have the dynamic range, power, modular cost approach, phase noise, dual use (radio, radar, jammer) and/or frequency and bandwidth agility.

Fundamentally, the device is a low cost, high volume manufacturable for 5G applications. It is able to go through glass and buildings by adjusting wireless frequency or medium like fiber optics, ethernet and/or any other protocol out there. The device can be use as a repeater at any frequency and a signal booster at any range.

### BRIEF SUMMARY OF THE INVENTION

It is an objective of the present invention to provide converter systems that allow for universal radio system that can be use at any frequency, bandwidth and protocol as specified in the independent claims. Embodiments of the invention are given in the dependent claims. Embodiments of the present invention can be freely combined with each other if they are not mutually exclusive.

One of the unique and inventive technical features of the present invention is the implementation and integration of the converter assembly, switch matrix assembly and the antenna elements while eliminating substantial cost and size due to cable assemblies. Furthermore, the ability to create low phase noise oscillator frequencies, a novel approach to filtering and the creating of a low cost antenna element makes the device a novel creation. Without wishing to limit the invention to any theory or mechanism, it is believed that the technical feature of the present invention advantageously provides lowest phase noise, most dynamic range, highest power with 360 degree coverage for 5G and radar applications. None of the presently known prior references or work has the unique inventive technical feature of the present invention.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a non-limiting schematic of the present invention.

FIG. 2 shows another non-limiting schematic of the present invention

### DETAILED DESCRIPTION OF THE INVENTION

Following is a list of elements corresponding to a particular element referred to herein:

101 field programmable gate array (FPGA)

103 signal converter

104 switch matrix

105 local oscillator

106 wireless transceiver

107 antenna

201 FPGA

202 phase locked loop

203 loop offset circuit

204 mixer

210 reference oscillation

211 phase locked loop

212 offset signal

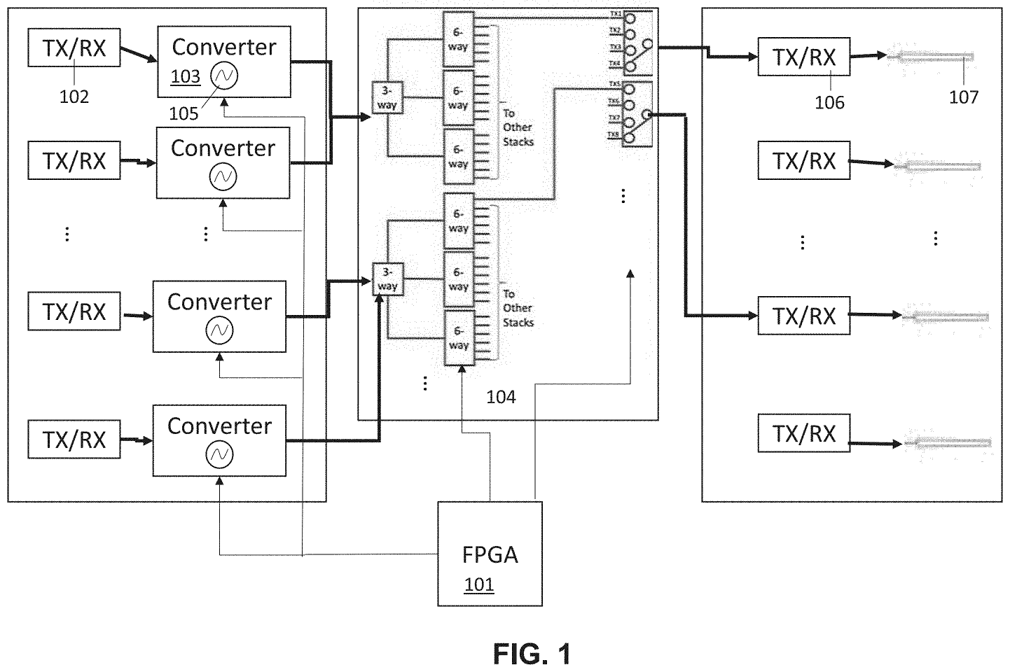

Referring now to FIG. 1, in some embodiments, the present invention features a multi-input, multi-output reconfigurable wireless converter. The converter may comprise a plurality of signal converters (103), a plurality of wireless transceivers (106), a plurality of antennas (107), a switch matrix (104), and a field programmable gate array (FPGA) (101). In other embodiments, the converter may further comprise a plurality of input transceivers. In one embodiment, each converter may comprise an input, an output, a transmit channel, a receive channel, a first switch, and a second switch. In some embodiments, each converter is capable of being configured to either send or receive signals. The converter is also capable of converting a signal between a first frequency that is configurable, and a second frequency.

In some embodiments, the transmit channel may comprise a mixer operatively connected to the input, a local oscillator (105) operatively connected to the mixer, a filter operatively connected to the output of the mixer, and a radio frequency amplifier operatively connected to the output of the filter. The mixer may be capable of mixing a signal at the first frequency with the output oscillation of a local oscillator and producing an output signal at the second frequency. The local oscillator (105) may be capable of generating an oscillation at a conversion frequency that is configurable. For instance, the conversion frequency is configured such that output of the mixer converts the signal to the second frequency. In one embodiment, the filter may be configured to filter the output of the mixer to pass frequency components within a bandwidth of the second frequency. In another embodiment, the radio frequency amplifier may be capable of amplifying the output signal of the filter.

In some embodiments, the receive channel may comprise a mixer operatively connected to the output, a local oscillator (105) operatively connected to the mixer, a filter operatively connected to the output of the mixer, and a radio frequency amplifier operatively connected to the output of the filter. The mixer may be capable of mixing a signal at the second frequency with the output oscillation of a local oscillator, producing an output signal at the first frequency. The local oscillator (105) may be capable of generating an oscillation at a conversion frequency that is configurable. In one embodiment, the conversion frequency is configured such that output of the mixer converts the signal to the first frequency. In some embodiments, the filter may be configured to filter the output of the mixer to pass frequency components within a bandwidth of the first frequency. In other embodiments, the radio frequency amplifier may be capable of amplifying the output signal of the filter.

In other embodiments, the first switch is operatively connected to the input of the converter, and to the mixer of the transmit channel and the amplifier of the receive channel. In some other embodiments, the second switch is operatively connected to the output of the converter, and to the amplifier of the transmit channel and the mixer of the receive channel.

In some embodiments, each antenna may be operatively connected to at least one of the plurality of wireless transceivers. In one embodiment, the wireless transceivers (106) are capable of sending and receiving wireless signals at the second frequency. In another embodiment, the antennas (107) are capable of sending and receiving wireless signals at the second frequency. In other embodiments, the switch matrix (104) may be operatively connected to the plurality of converters and the plurality of transceivers. The switch matrix (104) is capable of being configured to route a signal between any of the plurality of converters to any of the second plurality of transceivers. In further embodiments, the input transceivers may be operatively connected to the FGPA and are capable of receiving wireless signals having a plurality of frequencies and protocols.

In some embodiments, the field programmable gate array may be operatively connected to the converter assembly, the switch matrix, and the plurality of transceivers. Preferably, the FPGA is reprogrammable and can be programmed to transmit and receive signals having a plurality of wireless protocols. In one embodiment, the FPGA may be configured to execute software. The software execution may comprise configuring each of the converters to act as a transmit channel or a receive channel, comprising setting the first and second switches of the converter to route a signal through either the transmit channel or the receive channel of the converter; configuring each of the plurality of converters to convert a signal between a first wireless protocol and a second wireless protocol, comprising configuring the local oscillator of the wireless converter to the frequency needed to convert the signal from the first frequency to the second frequency when the transmit channel is active, or from the second frequency to the first frequency, when the receive channel is active; configuring the switch matrix to connect each of the plurality of wireless converters to one of the second plurality of wireless transceivers; sending a signal at the first frequency to the transmit channel of at least one of the plurality of converters; and receiving a signal at the first frequency from the receive channel of at least one of the plurality of converters.

In some embodiments, the FPGA sends a wireless signal to at least one of the converters. The FGPA can configure the local oscillator of the converter to a conversion frequency. The FGPA can also configure the first and second switches of the converter to use the transmit channel of the converter, and the frequency of the local oscillator to the frequency needed to upconvert the signal from the first frequency to the second frequency. The signal can be mixed with the frequency of the local oscillator and filtered to remove frequency components not within the bandwidth of the second frequency. The switch matrix can route the signal from the converter to at least one of the second plurality of transceivers, and the signal is transmitted by the antenna which is operatively connected to the transceiver.

In one embodiment, when a wireless signal is received by one of the antennas, it is received by the transceiver that is connected to the antenna, and routed by the switch matrix to one of the plurality of wireless converters. The FPGA can configure the converter to the receive channel of the converter, and the local oscillator to the frequency needed to convert the signal from the second frequency to the first frequency. The signal is converted from the second frequency to the first frequency and filtered to remove frequency components not within the bandwidth of the first frequency. The resulting signal is then received by the FPGA.

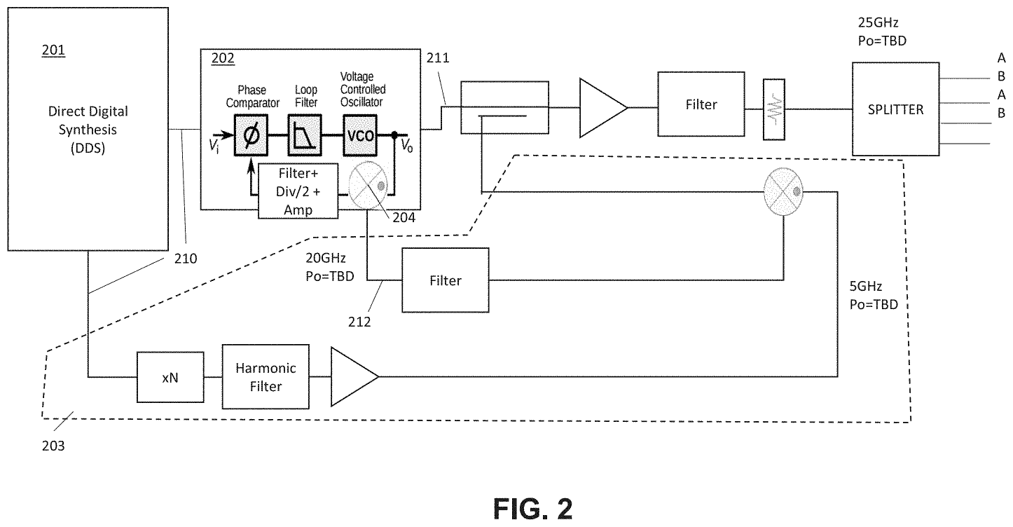

Referring to FIG. 2, in some embodiments, the local oscillator may comprise a phase locked loop (PLL) (202), a mixer, and a loop offset circuit (203). The PLL (202) may be operatively connected to a reference oscillation (210) of the FPGA. The PLL (202) is capable of generating a phase locked oscillation at a desired frequency (211) having a feedback path. The feedback path may comprise the mixer. The inputs of the mixer may be operatively connected to the outputs of the phase locked loop and the loop offset circuit. The output may be connected to the feedback path of the phase locked loop. In one embodiment, the loop offset circuit (203) is operatively connected to the reference oscillation of the FPGA, and to the mixer of the phase locked loop. The loop offset circuit can generate an offset signal (212) that is mixed by the mixer of the phase locked loop with the output signal of the phase locked loop (211). The resulting signal is shifted in frequency to frequency of the reference oscillation of the FPGA and fed back to the feedback loop of the phase locked loop.

In one embodiment, the antennas may comprise a microstrip and a stripline helix to create a polyrod antenna. The polyrod antennas and the transceivers may be integrated into stack assemblies on a printed circuit board. In another embodiment, the switch matrix may be configured to route a signal from any of the plurality of wireless transceivers to any other of the plurality of wireless transceivers. Consequently, the converter acts as a repeater. In some embodiments, the plurality of wireless transceivers automatically adjusts the power levels of the outgoing signal during transmission.

In a non-limiting embodiment, the second frequency may be 28 GHz. Accordingly, the FPGA may be programmed to convert between a first protocol and a 5G protocol.

As used herein, the term “about” refers to plus or minus 10% of the referenced number.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. Moreover, reference numbers recited in the below claims are solely for ease of examination of this patent application, and are exemplary, and are not intended in any way to limit the scope of the claims to the particular features having the corresponding reference numbers in the drawings. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

What is claimed is:

1. A multi-input, multi-output reconfigurable wireless converter, comprising:
a. a plurality of signal converters (103), wherein each converter is capable of being configured to either send or receive signals, wherein each converter is capable of converting a signal between a first frequency, wherein the first frequency is configurable, and a second frequency, wherein each converter comprises:
i. an input;
ii. an output;
iii. a transmit channel, comprising:
1. a mixer, operatively connected to the input, capable of mixing a signal at the first frequency with the output oscillation of a local oscillator, producing an output signal at the second frequency;
2. the local oscillator (105), operatively connected to the mixer, capable of generating an oscillation at a conversion frequency, wherein the conversion frequency is configurable, wherein the conversion frequency is configured such that output of the mixer converts the signal to the second frequency;
3. a filter, operatively connected to the output of the mixer, configured to filter the output of the mixer to pass frequency components within a bandwidth of the second frequency; and
4. a radio frequency amplifier, operatively connected to the output of the filter, capable of amplifying the output signal of the filter;
iv. a receive channel, comprising:
1. a mixer, operatively connected to the output, capable of mixing a signal at the second frequency with the output oscillation of a local oscillator, producing an output signal at the first frequency;
2. the local oscillator (105), operatively connected to the mixer, capable of generating an oscillation at a conversion frequency, wherein the conversion frequency is configurable, wherein the conversion frequency is configured such that output of the mixer converts the signal to the first frequency;
3. a filter, operatively connected to the output of the mixer, configured to filter the output of the mixer to pass frequency components within a bandwidth of the first frequency; and
4. a radio frequency amplifier, operatively connected to the output of the filter, capable of amplifying the output signal of the filter;
v. a first switch, operatively connected to the input of the converter, and to the mixer of the transmit channel and the amplifier of the receive channel; and
vi. a second switch, operatively connected to the output of the converter, and to the amplifier of the transmit channel and the mixer of the receive channel;
b. a plurality of wireless transceivers (106), capable of sending and receiving wireless signals at the second frequency;
c. a plurality of antennas (107), capable of sending and receiving wireless signals at the second frequency, wherein each antenna is operatively connected to at least one of the plurality of wireless transceivers;
d. a switch matrix (104), operatively connected to the plurality of converters and the plurality of transceivers, capable of being configured to route a signal between any of the plurality of converters to any of the second plurality of transceivers; and
e. a field programmable gate array (FPGA) (101), operatively connected to the converter assembly, the switch matrix, and the plurality of transceivers, wherein the FPGA is reprogrammable, wherein the FPGA can be programmed to transmit and receive signals having a plurality of wireless protocols, wherein the FPGA is configured to execute software comprising:
i. configuring each of the converters to act as a transmit channel or a receive channel, comprising setting the first and second switches of the converter to route a signal through either the transmit channel or the receive channel of the converter;
ii. configuring each of the plurality of converters to convert a signal between a first wireless protocol and a second wireless protocol, comprising configuring the local oscillator of the wireless converter to the frequency needed to convert the signal from the first frequency to the second frequency when the transmit channel is active, or from the second frequency to the first frequency, when the receive channel is active;
iii. configuring the switch matrix to connect each of the plurality of wireless converters to one of the second plurality of wireless transceivers;
iv. sending a signal at the first frequency to the transmit channel of at least one of the plurality of converters; and
v. receiving a signal at the first frequency from the receive channel of at least one of the plurality of converters;
wherein the FPGA sends a wireless signal to at least one of the converters, wherein the FGPA configures the local oscillator of the converter to a conversion frequency, wherein the FPGA configures the first and second switches of the converter to use the transmit channel of the converter; wherein the FPGA configures the frequency of the local oscillator to the frequency needed to upconvert the signal from the first frequency to the second frequency, wherein the signal is mixed with the frequency of the local oscillator, wherein the signal is filtered to remove frequency components not within the bandwidth of the second frequency, wherein the switch matrix routes the signal from the converter to at least one of the second plurality of transceivers, wherein the signal is transmitted by the antenna which is operatively connected to the transceiver;
wherein when a wireless signal is received by one of the antennas, it is received by the transceiver that is connected to the antenna, wherein it is routed by the switch matrix to one of the plurality of wireless converters, wherein the FPGA configures the converter to the receive channel of the converter, wherein the FPGA configures the local oscillator to the frequency needed to convert the signal from the second frequency to the first frequency, whereupon the signal is converted from the second frequency to the first frequency, whereupon the signal is filtered to remove frequency components not within the bandwidth of the first frequency, wherein the resulting signal is received by the FPGA.

2. The converter of claim 1, further comprising a plurality of input transceivers, operatively connected to the FGPA, capable of receiving wireless signals having a plurality of frequencies and protocols.

3. The converter of claim 1, wherein the local oscillator comprises:
a. a phase locked loop (PLL) (202), operatively connected to a reference oscillation (210) of the FPGA (201), capable of generating a phase locked oscillation at a desired frequency (211), having a feedback path, wherein the feedback path comprises a mixer;
b. the mixer (204), wherein the inputs of the mixer are operatively connected to the outputs of the phase locked loop and a loop offset circuit, wherein the output is connected to the feedback path of the phase locked loop; and
c. the loop offset circuit (203), operatively connected to the reference oscillation of the FPGA, and to the mixer of the phase locked loop, wherein the loop offset circuit generates an offset signal;
wherein the offset signal (212) is mixed by the mixer of the phase locked loop with the output signal of the phase locked loop (211), wherein the resulting signal is shifted in frequency to frequency of the reference oscillation of the FPGA, wherein the resulting signal is fed back to the feedback loop of the phase locked loop.

4. The converter of claim 1, wherein the antennas comprise a microstrip and a stripline helix to create a polyrod antenna.

5. The converter of claim 4, wherein the polyrod antennas and the transceivers are integrated into stack assemblies on a printed circuit board.

6. The converter of claim 1, wherein the switch matrix is configured to route a signal from any of the plurality of wireless transceivers to any other of the plurality of wireless transceivers, wherein the converter consequently acts as a repeater.

7. The converter of claim 1, wherein the plurality of wireless transceivers automatically adjusts the power levels of the outgoing signal during transmission.

8. The converter of claim 1, wherein the second frequency is 28 GHz.

9. The converter of claim 8, wherein the FPGA is programmed to convert between a first protocol and a 5G protocol.
